(19) United States
(12) Patent Application Publication
(10) Pub. No.: US 2026/0350681 A1
(43) Pub. Date: Nov. 5, 2026

(54) SELECTIVELY DISPLAYING ITEM IN A USER INTERFACE BASED ON MACHINE LEARNING MODEL PREDICTION OF ALTERNATIVE ITEMS

(71) Applicant: Maplebear Inc., San Francisco, CA (US)

(72) Inventor: Naval Shah, Toronto (CA)

(21) Appl. No.: 19/194,701

(22) Filed: Apr. 30, 2025

(51) Int. Cl. G06Q 30/0601; G06F 16/9535; G06Q 10/087; G06Q 30/0283

(52) U.S. Cl. CPC G06Q 30/0631; G06F 16/9535; G06Q 10/087; G06Q 30/0283

(57) ABSTRACT

The online system trains a machine learning model to infer whether to display an item at a user interface, where the item was requested by a user of the online system. To determine whether to show the item to the user, the online system trains the machine learning model that predicts not just whether the requested item is available at a source, but also whether a suitable replacement item is in stock in case the requested item is not actually available at the source. To train the machine learning model, the online system uses order history for a collection of users, labels indicative of whether originally requested items or suitable replacements were available, and optionally user specific ordering signals. The online system uses the prediction generated by the trained machine learning model to determine whether to show the item at the user interface.

### BACKGROUND

Online systems such as e-commerce platforms allow users to interact with items, including searching for items and placing online orders. These online systems may employ machine learning models to predict item availability to determine whether an item should be displayed in the user interface. Some online systems also allow users to select replacement items if the originally ordered item is determined to be out of stock. But traditional availability prediction models are generally trained to estimate the probability that a specific item is in stock at the time of user interaction. These models typically do not account for the availability of suitable replacement items, nor whether such replacements would be acceptable to the user. As a result, items may be withheld from display if they are predicted to be unavailable, even in cases where the online system could have fulfilled the order using an alternative item acceptable to the user.

This leads to a technical problem in how machine learning models are applied to availability prediction. For example, existing models operate with a narrow prediction target—i.e., the availability of a specific item—and lack the capability to assess fulfillment feasibility in a more flexible or adaptive manner. There is a need for an improved prediction model that incorporates both item-level availability and the likelihood that the online system can fulfill a request using an acceptable substitute. Such a model would allow the online system to make more informed decisions about when to surface items in the user interface, enabling more effective use of inventory and a more resilient response to stock variability, while preserving system responsiveness and prediction accuracy.

### SUMMARY

Embodiments of the present disclosure are directed to training and using a machine learning model to determine whether an online system should display an item in a user interface of a device associated with a user of the online system. More specifically, the online system presented herein selectively displays the item in the user interface based on a machine learning model prediction of availability of alternative items.

In accordance with one or more aspects of the disclosure, the online system receives, via a network and from the device associated with the user, an ordering signal including a request for an item from a source. Responsive to receiving the ordering signal, the online system retrieves, from a database of the online system, a set of features of the item. Responsive to receiving the ordering signal, the online system generates an item status signal with an indication about a real time status of the item at the source. Responsive to the item status signal indicating a potential unavailability of the item at the source, the online system obtains, based at least in part on the set of features of the item, a set of candidate replacement items for replacing the item. The online system then accesses an availability prediction model.

The training process for the availability prediction model can occur in two stages. In the first stage, the online system retrieves, from the database, information about a training set of conversions conducted by a training set of users of the online system and a set of labels, each label from the set of labels indicative of whether an originally requested item or a replacement item for replacing the originally requested item was available at a corresponding source during each conversion of the training set of conversions. The online system then applies the availability prediction model to the information about the training set of conversions to generate an output for each conversion of the training set of conversions that is indicative of a likelihood that the originally requested item or the replacement item was available at the corresponding source. The online system compares the output for each conversion of the training set of conversions to a respective label from the set of labels, and updates, using a result of comparing the output for each conversion to the respective label, a set of parameters of the availability prediction model.

In the second stage, the online system retrieves, from the database and for a plurality of conversions conducted by the user, user data including information about acceptance of alternative items instead of originally requested items for the user. The online system further retrieves, from the database, a plurality of labels, each of the plurality of labels indicative of whether an item originally requested by the user or a corresponding alternative item for replacing the item originally requested by the user was available during each of the plurality of conversions. The online system then applies the availability prediction model to the user data to generate a user specific output for each of the plurality of conversions that is indicative of a likelihood that the item originally requested by the user or the corresponding alternative item was available. The online system compares the user specific output for each of the plurality of conversions to a respective label of the plurality of labels, and updates, using a result of comparing the user specific output to the respective label, the set of parameters of the availability prediction model.

The online system applies the availability prediction model to the set of features of the item, the item status signal, and the set of candidate replacement items to generate an availability score for the item that is indicative of a likelihood that the item or an alternative item for replacing the item is available at the source. The online system compares the availability score for the item to a threshold score. The online system generates, using information about the item and when the availability score for the item is greater than the threshold score, a user interface signal. The online system sends, via the network, the user interface signal to the device associated with the user, wherein the sending the user interface signal causes the device associated with the user to display a user interface with the information about the item and a user interface element for adding the item to a cart of the user.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example architectural flow diagram of training and using a machine learning model to predict whether an online system should display an item at a user interface of the online system, in accordance with one or more embodiments.

FIG. 4 is a flowchart for a method of training and using a machine learning model to predict whether an online system should display an item at a user interface of the online system, in accordance with one or more embodiments.

### DETAILED DESCRIPTION

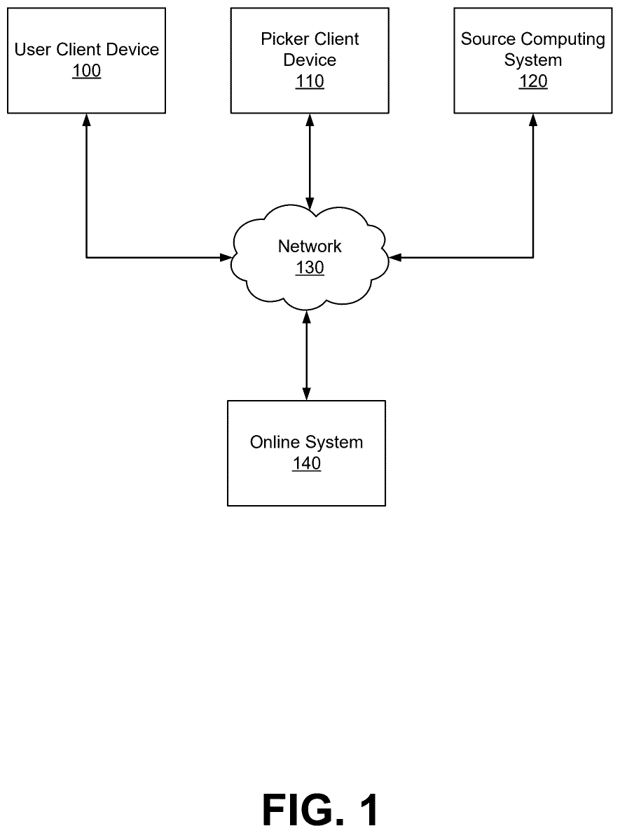

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker (i.e., fulfillment agent, servicing agent, or agent) that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a source location. The user's order may specify which groceries they want to be delivered from the source location and the quantities of each of the groceries. The user client device 100 transmits the user's order to the online system 140 and the online system 140 selects a picker to travel to the source location to collect the groceries ordered by the user. The online system 140 transmits an offer to the picker for the picker to service the order in exchange for consideration and, if the picker accepts the offer, the picker collects the groceries from the source location. Once the picker has collected the groceries ordered by the user, the picker delivers the groceries to a location transmitted to the picker client device 110 by the online system 140.

Users of the online system 140 select a source and browse item categories or use the search function to find items on their shopping lists. Item availability is typically presented as a static value to all users indicating general stock levels such as “in stock,” “low stock,” or “out of stock.” This uniform approach does not account for individual user preferences or behaviors. An issue may arise when an item a user wants is marked as out of stock. While users can pre-select replacements for such items—specifying alternative items they are willing to accept—the online system 140 does not consider these preferred replacements when displaying item availability. As a result, users may believe they cannot purchase an item or its acceptable substitutes, leading to abandoned carts and lost sales opportunities. Moreover, when a picker cannot find the requested item, the picker chooses a replacement per the user's prior selections or based on what the picker knows to be a suitable replacement. However, this substitution only occurs after an order is placed, which does not help in retaining users who are deterred by initial out-of-stock indications.

By applying the traditional item availability process flow, the online system 140 avoids displaying stock items to a user when in fact, the user may be very satisfied with one of the replacements, e.g., either with a replacement that the online system 140 ranks high or with a replacement that the user has selected before. This means that the online system 140 can facilitate building a fuller cart and reaching a minimum order and pick up critical mass. This would increase gross transaction volume (GTV) and a number of orders, but also provide satisfaction to users and sources.

Thus, the main issue with the uniform approach for item availability is the lack of a personalized availability score for items that would take into account individual user data, including their replacement preferences, order history, satisfaction levels from previous orders, and/or the current context of items in their cart. Without this personalized insight, the online system 140 may fail to present a more accurate and user specific view of item availability. This limitation may affect the overall shopping experience and business performance. It may reduce GTV for each cart by not maximizing or at least increasing the availability of items during the ordering session. It may also decrease the number of completed orders, as users may abandon their ordering sessions if key items appear unavailable. Consequently, sources may miss out on potential sales, and pickers may lose earning opportunities due to fewer orders to fulfill. By addressing this issue, the online system 140 can enhance user satisfaction through personalized ordering experiences, increase GTV by capturing sales that would otherwise be lost, and provide more value to both sources and pickers.

The online system 140 provides a user interface to enable users to select items to convert on. To determine whether to show an item to a user, the online system 140 may traditionally use an availability model that predicts whether the item is in stock. However, since the online system 140 also allows a user to select a replacement item if an ordered item is in fact not in stock, the online system 140 uses a modified availability model that predicts not just whether a requested item is in stock, but also whether a suitable replacement item is in stock in case the requested item is not actually available.

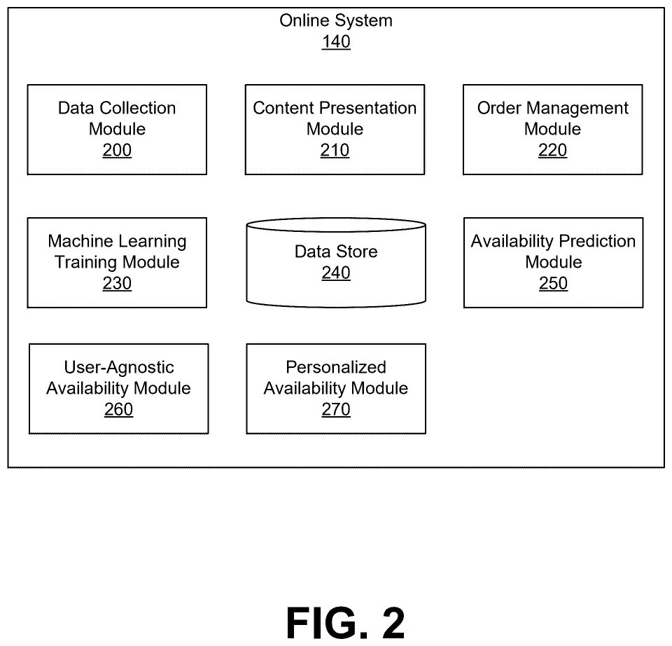

The online system 140 trains the modified availability model to predict not just the availability of a specific item, but of that item or a suitable replacement item. To train the modified availability model, the online system 140 may use general order history and/or transaction history of a specific user, along with current session signals and data to personalize item availability. The online system 140 may use the prediction generated by the modified availability model to determine whether to show the item at a user interface of the user client device 100. Deployment of the modified availability model may enable the online system 140 to show items more often, which leads to higher conversion rates and user satisfaction. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine learning training module 230, a data store 240, an availability prediction module 250, a user-agnostic availability module 260, and a personalized availability module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine learning training module 230 trains machine learning models used by the online system 140. The online system 140 may use machine learning models to perform functionalities described herein. Example machine learning models include regression models, support vector machines, naïve Bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, transformers, large-language models, or multi-modal large language models. A machine learning model may include components relating to these different general categories of model, which may be sequenced, layered, or otherwise combined in various configurations. While the term “machine learning model” may be broadly used herein to refer to any kind of machine learning model, the term is generally limited to those types of models that are suitable for performing the described functionality. For example, certain types of machine learning models can perform a particular functionality based on the intended inputs to, and outputs from, the model, the capabilities of the system on which the machine learning model will operate, or the type and availability of training data for the model.

Each machine learning model includes a set of parameters. The set of parameters for a machine learning model are parameters that the machine learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters (e.g., the particular values of the parameters) for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, picker data, item data, or order data. In some cases, the training examples also include a label which represents an expected output of the machine learning model. In these cases, the machine learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine learning training module 230 may apply an iterative process to train a machine learning model whereby the machine learning training module 230 updates parameter values of the machine learning model based on each of the set of training examples. The training examples may be processed together, individually, or in batches. To train a machine learning model based on a training example, the machine learning training module 230 applies the machine learning model to the input data in the training example to generate an output based on a current set of parameter values. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

In some embodiments, the machine learning training module 230 may retrain the machine learning model based on the actual performance of the model after the online system 140 has deployed the model to provide service to users. For example, if the machine learning model is used to predict a likelihood of an outcome of an event, the online system 140 may log the prediction and an observation of the actual outcome of the event. Alternatively, if the machine learning model is used to classify an object, the online system 140 may log the classification as well as a label indicating a correct classification of the object (e.g., following a human labeler or other inferred indication of the correct classification). After sufficient additional training data has been acquired, the machine learning training module 230 re-trains the machine learning model using the additional training data, using any of the methods described above. This deployment and re-training process may be repeated over the lifetime use for the machine learning model. This way, the machine learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

The availability prediction module 250 may access an availability prediction model (e.g., machine learning model) that is trained to predict a likelihood of a user being able to fill an order with either an originally requested item or a replacement item with which the user would be satisfied. The availability prediction module 250 may deploy the availability prediction model to run a machine learning algorithm to input signals to output an availability score for the user that is indicative of the likelihood that the user will successfully receive the originally requested item or the satisfactory replacement. The availability score may be a value between 0 and 1, where a lower value of the availability score may indicate a lower likelihood that the user will successfully receive the originally requested item or the satisfactory replacement, and a higher value of the availability score may indicate a higher likelihood that the user will successfully receive the originally requested item or the satisfactory replacement. A set of parameters for the availability prediction model may be stored at one or more non-transitory computer-readable media of the availability prediction module 250. Alternatively, the set of parameters for the availability prediction model may be stored at one or more non-transitory computer-readable media of the data store 240.

In providing the input signals to the availability prediction model, the availability prediction module 250 may provide information about an availability of a requested item, information about replacements for the requested item, user transaction history signals, cart session information, a minimum order size for free delivery, some other information suitable for inferring an item availability, or some combination thereof. In providing the information about the availability of the requested item to the availability prediction model, the availability prediction module 250 may provide information about a real-time stock status of the requested item, including a current inventory level at a source. The availability prediction module 250 may receive the information about the availability of the requested item from a source computing system 120 via the network 130. In providing the information about the replacements for the requested item to the availability prediction model, the availability prediction module 250 may provide a list of alternative items that can serve as suitable substitutes for the requested item. The list of alternative items may include replacements suggested by the online system 140 (e.g., inferred by a machine learning model) based on item similarity, popularity, and/or availability. The list of alternative items may further include user-selected replacements, i.e., specific alternatives previously chosen by the user, either from past conversions or prior replacement selections. The availability prediction module 250 may retrieve the user-selected replacements from a user catalog database (e.g., part of the data store 240).

In providing the user transaction history signals to the availability prediction model, the availability prediction module 250 may provide information about willingness of the user to accept replacements, i.e., data indicating how frequently the user opts for replacements over refunds when items are unavailable. In providing the user transaction history signals to the availability prediction model, the availability prediction module 250 may further provide information about the user's satisfaction with replacements, i.e., historical feedback on the user's happiness or dissatisfaction with past replacements, including metrics on accepted replacements versus requested refunds. The availability prediction module 250 may retrieve the user transaction history signals from the user catalog database.

In providing the cart session information to the availability prediction model, the availability prediction module 250 may provide information about a number of items in the cart and/or a total cart value. The information about the number of items in the cart may include a total count of items currently in the user's cart. The total cart value may be a cumulative monetary value of the items in the cart. In providing information about the minimum order size for free delivery to the availability prediction model, the availability prediction module 250 may provide a threshold that the user needs to meet to qualify for free delivery (e.g., $10 or $35 minimum order value). The cart session information and the minimum order size for free delivery as inputs to the availability prediction model may influence an increase of the availability score for the item, when the user has not yet built their free delivery order. In such a manner, the online system 140 is more permissive to show to the user the out-of-stock item in order to prompt the user to build their free delivery order.

In one or more embodiments, the availability prediction module 250 may deploy the availability prediction model to run a machine learning algorithm to the aforementioned input signals to generate a personalized availability score for each item during the user's ordering session. The availability score may account for both actual availability of the requested item and the user's likelihood to accept replacements based on their past behavior and preferences. By integrating these factors, the availability prediction model provides a more accurate representation of item availability from the user's perspective.

The machine learning training module 230 may perform training of the availability prediction model. Training data for the availability prediction model may include a training set of data and a set of labels. The training set of data may include information about historical conversions conducted by a training set of users of the online system 140 over a defined time period. The training set of data may further include user specific signals, such as information about historical acceptance of replacement suggestions for a user from the training set of users. Each label in the set of labels may include an indication on whether an originally requested item or a suitable replacement was available during each conversion retrieved from the order catalog database. The machine learning training module 230 may retrieve the training set of data and the set of labels from an order catalog database and/or a user catalog database, e.g., from the data store 240. The machine learning training module 230 may train the availability prediction model using the training data to generate initial values for the set of parameters of the availability prediction model.

In one or more embodiments, the user-agnostic availability module 260 deploys the availability prediction model to run a machine learning algorithm to only item specific input signals (e.g., user context agnostic signals) to generate an availability score that is indicative of a likelihood that any user of the online system 140 will successfully receive an originally requested item or a satisfactory replacement. Thus, in such cases, the availability prediction model may generate an availability score that is user-agnostic. In providing the item specific input signals to the availability prediction model, the user-agnostic availability module 260 may provide information about an availability of a requested item, information about replacements for the requested item, information about taxonomy of the requested item, information about taxonomy of the replacements, a minimum order size for free delivery, some other user-agnostic information suitable for inferring an item availability, or some combination thereof.

Traditionally, the online system 140 may not adjust scoring thresholds for available items signals at a user interface based on the specific item or item catalog taxonomy. In other words, the “bar” for displaying an item at the user interface as an available item may be constant across the item catalog database. By deploying the availability prediction model to run a machine learning algorithm to only user-agnostic signals, the online system 140 may adjust availability scoring based on the item itself. For example, if an item has readily available high-fidelity replacements (e.g., a common size of 2% organic milk), the user-agnostic availability module 260 may deploy the availability prediction model to blend the replacement items'availability into the core item's availability score to boost the item's availability score up. In contrast, if an item is unique and has very few viable replacements, the user-agnostic availability module 260 may deploy the availability prediction model to lower an item's availability score accordingly.

In one or more embodiments, upon generating a user-agnostic (or universal) availability score for a given item, the personalized availability module 270 deploys the availability prediction model to run a machine learning algorithm to only user specific input signals to generate a personalized availability score for the item that represents an adjusted value of the user-agnostic availability score. In providing the user specific input signals to the availability prediction model, the personalized availability module 270 may provide information about the user's conversion history, information about a current user's session (e.g., content of a current's user's cart, information about items the user engaged with during the current session, etc.), some other user specific data suitable for inferring an item availability, or some combination thereof.

The online system 140 may utilize an availability score (e.g., a user-agnostic availability score or a personalized availability score) for an item generated by the availability prediction model to decide whether to show the item at a user interface of the user client device. In this manner, the online system 140 may render personalized item availability for users when they are ordering items at the online system 140. In particular, the content presentation module 210 may compare the availability score to a threshold score. If the availability score is above the threshold score, the content presentation module 210 may use information about the item to generate a user interface signal. The content presentation module 210 may send, via the network 130, the user interface signal to the user client device 100 causing the user client device 100 to display the user interface with the information about the item and a user interface element for use by the user to add the item to a cart. The user may utilize the user interface element to add the item shown at the user interface to the cart.

The machine learning training module 230 may collect feedback data with information about a user's response in relation to a replacement item delivered to the user instead of the originally requested item that was out of stock. The feedback data may be recorded at the user client device 100 or at the picker client device 110 associated with a picker who delivered an order with the replacement item to the user and communicated, via the network 130, to the online system 140 and the machine learning training module 230. The feedback data may include communication data exchanged between the user client device 100 and the picker client device 110 via the network 130 with information about the user's satisfaction with the replacement item that was delivered to the user instead of the originally requested out-of-stock item. The machine learning training module 230 may then re-train the availability prediction model by updating the set of parameters of the availability prediction model using the feedback data. By collecting feedback data with information about replacement satisfactions from various users of the online system 140, the availability prediction model may be re-trained and continuously improved over time.

By applying the availability prediction model as described herein, it is more likely to show an item at a user interface than by utilizing the traditional availability model that takes into account only those features that are related to a requested item. By utilizing the new availability prediction model to provide individualized availability scores, users of the online system 140 may receive a shopping experience tailored to their preferences and past behaviors. This approach can be also applied across marketplace and white-label entities, as well as any integrations with developer platforms.

An example process flow at the online system 140 may start via a user's initiation, i.e., when the user opens an application of the online system 140 running on the user client device 100 and selects a source associated with the online system 140. Then, the user may use a search interface at the user client device 100 to search for a specific item, e.g., for “organic blueberries,” which are currently out of stock at the source. After that, the online system 140 may deploy the availability prediction model to run a machine learning algorithm to user-agnostic input signals and optionally to user specific input signals to generate an availability score for the item that is indicative of a likelihood that the user will accept a suitable replacement for the item, e.g., based on previous conversion behavior and replacement preferences related to a collection of users of the online system 140 or the specific user.

Based on the availability score being above a threshold score, the online system 140 displays the item (e.g., organic blueberries) at the user interface of the user client device 100 as “in stock” for this user, knowing that a preferred replacement item is available. The user utilizes a user interface element to add the item (e.g., organic blueberries) to their cart and continues the ordering session at the online system 140 unaware of the out-of-stock status of the item since an acceptable replacement item is anticipated by the online system 140. The user then completes their ordering session and proceeds to checkout, placing the order at the online system 140.

A picker may receive information about the order at the picker client device 110 from the user client device 100 via the network 130, and then goes to a source location to fulfill the order. Upon finding that the item (e.g., organic blueberries) is indeed out of stock, the picker selects another item (e.g., regular blueberries) as a replacement, e.g., following the user's prior replacement selections and preferences. The user receives the order with the replacement item (e.g., regular blueberries) replacing the originally requested item. Having previously accepted this replacement and provided positive feedback in past orders, the user is pleased with the substitution and enjoys a seamless ordering experience at the online system 140.

As aforementioned, by applying the availability prediction model to only user-agnostic input signals, the online system 140 can improve the item availability scoring even when personalization signals from a user's context are not available, e.g., when the user is interacting with the online system 140 in a guest user mode when user specific signals are not available. In such cases, the online system 140 relies on the item-specific availability scoring changes that do not require user context signals. This can also apply to both marketplace and white-label entities. Additionally, or alternatively, for many third-party applications, the user context is not present. For such cases, by applying the availability prediction model to only user-agnostic input signals, the online system 140 can adjust the item availability scoring at third-party online platforms, e.g., developer platforms.

The process flow of the online system 140 that integrates the availability prediction model can be efficiently applied across different online platforms. In the case of marketplace entities (e.g., sources), the online system 140 that integrates the availability prediction model as described herein may enhance the main online platform by improving perceived item availability, reducing cart abandonment rates, and increasing overall conversion rates. In the case of white-label entities, the online system 140 may apply the same personalized availability functionality to source-branded platforms powered by technology of the online system 140, offering their users an improved shopping experience. In the case of third-party platform (e.g., developer platform) integrations, by deploying the availability prediction model the online system 140 can extend personalized availability features to third-party applications and services integrated with the online system 140, ensuring consistency in user experience across different online platforms. This can be achieved once the third-party application has access to the user's account at the online system 140 upon obtaining explicit user's permission to obtain user specific context.

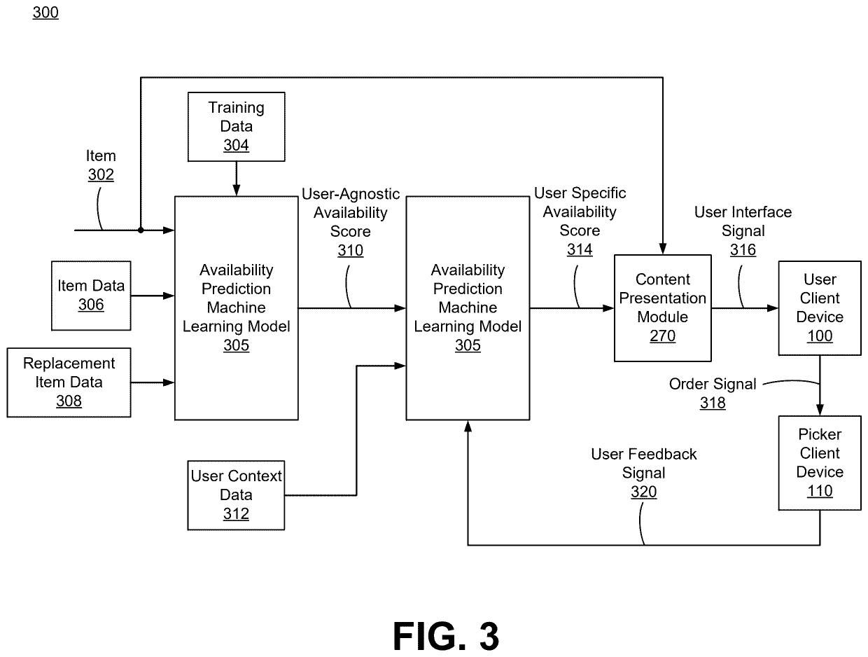

FIG. 3 illustrates an example architectural flow diagram 300 of training and using an availability prediction machine learning model 305 to predict whether the online system 140 should display an item at a user interface of the user client device 100, in accordance with one or more embodiments. The process flow starts when the online system 140 receives (e.g., at the order management module 220), via the network 130 and from the user client device 100 a request from a user of the online system 140 for an item 302. The order management module 220 may pass information about the item 302 to the availability prediction machine learning model 305.

Prior to running a machine learning algorithm of the availability prediction machine learning model 305, the online system 140 may perform (e.g., via the machine learning training module 230) initial training of the availability prediction machine learning model 305 using training data 304. The training data 304 may be generated (e.g., via the machine learning training module 230) by retrieving a training set of data and a set of labels from the order catalog database and/or the user catalog database, e.g., from the data store 240. The training set of data may include information about historical conversions conducted by a training set of users of the online system 140 over a defined time period. The training set of data may further include user specific signals, such as information about historical acceptance of replacement suggestions for the user. Each label in the set of labels may include an indication on whether an originally requested item or a suitable replacement was available during each conversion retrieved from the order catalog database. The machine learning training module 230 may train, using the training data 304 including the training set of data and the set of labels, the availability prediction machine learning model 305 to generate a set of initial values for a set of parameters of the availability prediction machine learning model 305.

After the training process is completed, the online system 140 may first provide user-agnostic inputs to the availability prediction machine learning model 305 (e.g., via the user-agnostic availability module 260). In addition to the information about the item 302 (e.g., description of the item 302, taxonomy information about the item 302, etc.), the online system 140 may provide item data 306 and replacement item data 308. Some additional user-agnostic inputs not shown in FIG. 3 suitable for inferring an item availability may be further provided to the availability prediction machine learning model 305.

In providing the item data 306 to the availability prediction machine learning model 305, the user-agnostic availability module 260 may provide information about a real-time stock status of the item 302, including a current inventory level at a source. The user-agnostic availability module 260 may receive the item data 306 in real time from the source computing system 120 via the network 130.

In providing the replacement item data 308 to the availability prediction machine learning model 305, the user-agnostic availability module 260 may provide a list of alternative items that can serve as suitable substitutes for the item 302, information about willingness of a set of users of the online system 140 to accept replacements for the item 302 (e.g., data indicating how frequently the set of users opted for replacements over refunds when the item 302 was unavailable), information about the satisfaction of the set of users with replacements for the item 302 (e.g., historical feedback on the users'satisfaction with past replacements for the item 302, including metrics on accepted replacements versus requested refunds), some other replacement specific data, or some combination thereof. The user-agnostic availability module 260 may retrieve the replacement item data 308 from the item catalog database and/or the user catalog database.

The availability prediction machine learning model 305 may apply the machine learning algorithm to the information about the item 302, the item data 306 and the replacement item data 308 to generate a user-agnostic (or universal) availability score 310 for the item 302. The user-agnostic availability score 310 may be a value between 0 and 1 that is indicative of a likelihood that any user of the online system 140 will successfully receive the item 302 or a satisfactory replacement for the item 302.

The personalized availability module 270 may provide the user-agnostic availability score 310 as a second-stage input into the availability prediction machine learning model 305. In addition to the user-agnostic availability score 310, the personalized availability module 270 may further provide user context data 312 to the availability prediction machine learning model 305.

In providing the user context data 312 to the availability prediction machine learning model 305, the personalized availability module 270 may provide a list of user-selected replacements for the item 302 (e.g., specific alternatives previously chosen by the user, either from past conversions or prior replacement selections), information about willingness of the user to accept replacements for the item 302, i.e., data indicating how frequently the user opted for replacements for the item over refunds when the item 302 was unavailable, information about the user's satisfaction with replacements for the item (e.g., historical feedback on the user's satisfaction with past replacements for the item, including metrics on accepted replacements for the item 302 versus requested refunds), cart session data with information about a number of items in a current user's cart and/or a total value of the current user's cart, information about a minimum order size for free delivery, some other user context data, or some combination thereof. The personalized availability module 270 may retrieve some of the user context data 312 from the user catalog database. Alternatively, or additionally, the personalized availability module 270 may receive some of the user context data 312 in real time from the user client device 100 via the network 130.

The availability prediction machine learning model 305 may apply the machine learning algorithm to the user context data 312 to generate a user specific (or personalized) availability score 314 for the item 302 that represents an adjusted (e.g., increased) value of the user-agnostic availability score 310. The user specific availability score 314 may be a value between 0 and 1 that is indicative of a likelihood that the specific user will successfully receive the item 302 or a satisfactory replacement for the item 302. The availability prediction machine learning model 305 may pass the user specific availability score 314 to the content presentation module 210.

The content presentation module 210 may compare the user specific availability score 314 to a threshold score. If the user specific availability score 314 is above the threshold score, the content presentation module 210 may use information about the item 302 to generate a user interface signal 316. The content presentation module 210 may send, via the network 130, the user interface signal 316 to the user client device 100 causing the user client device 100 to display a user interface with the information about the item 302 and a user interface element for use by the user to add the item 302 to a cart. The user may utilize the user interface element to add the item 302 shown at the user interface to the cart. Once the user finishes adding items to the cart including the item 302 and completes the check-out, the user client device 100 may generate an order signal 318 that is communicated to the picker client device 110 via the network 130.

Once a picker fulfills the order and delivers items to the user, the picker client device 110 may generate a user feedback signal 320 with information about a user's response in relation to a replacement item delivered to the user instead of the item 302 that was out of stock. The user feedback signal 320 may include communication data exchanged between the user client device 100 and the picker client device 110 via the network 130 with information about the user's satisfaction with the replacement item that was delivered to the user instead of the item 302.

The online system 140 may receive (e.g., at the machine learning training module 230) the user feedback signal 320 from the picker client device 110 (or the user client device 100) via the network 130. The machine learning training module 230 may utilize the user feedback signal 320 to re-train the availability prediction machine learning model 305. By utilizing user feedback signals 320 originating from various users of the online system 140 in relation to users'replacement satisfactions, the machine learning training module 230 may update the set of parameters of the availability prediction machine learning model 305 and continuously improve the machine learning algorithm of the availability prediction machine learning model 305.

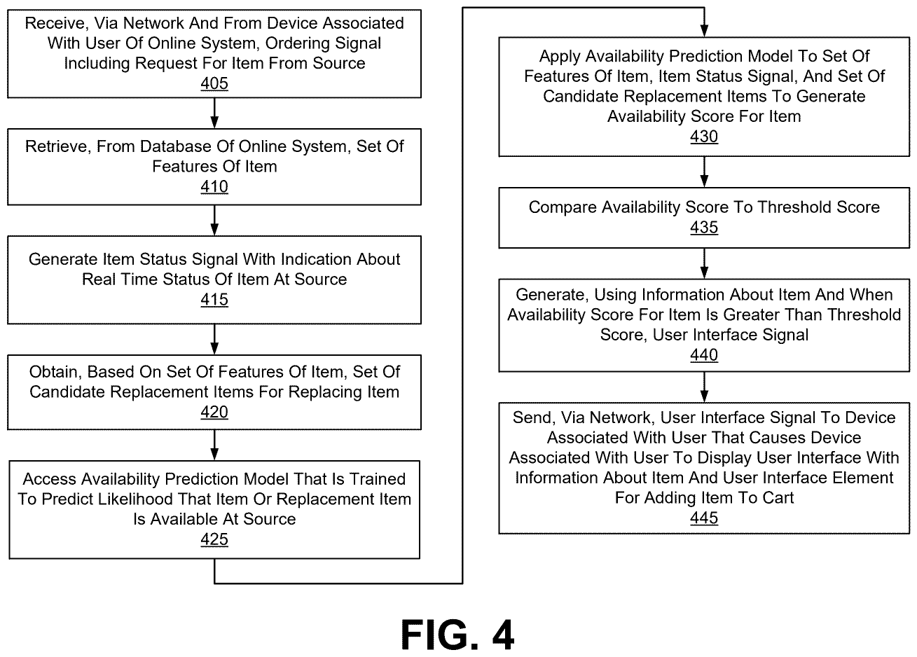

FIG. 4 is a flowchart for a method of training and using a machine learning model to predict whether an online system should display an item at a user interface of the online system, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the order management module 220), via a network (e.g., the network 130) and from a device associated with a user of the online system 140 (e.g., the user client device 100), an ordering signal including a request for an item from a source. When receiving the ordering signal, the online system 140 may receive (e.g., at the order management module 220), via the network and from the device associated with the user, a user mode signal that is indicative of the user not being logged in at an account of the user at the online system 140 when requesting the item. In such cases, the user is interacting with the online system 140 as a guest user, and the online system 140 cannot access any data specific for the user.

Responsive to receiving the ordering signal, the online system 140 retrieves 410 (e.g., via the availability prediction module 250), from a database of the online system 140 (e.g., the data store 240), a set of features of the item (e.g., taxonomy information of the item, item brand, item type, etc.). Responsive to receiving the ordering signal, the online system 140 generates 415 (e.g., via the availability prediction module 250) an item status signal with an indication about a real time status of the item at the source.

In one or more embodiments, responsive to receiving the ordering signal, the online system 140 may apply (e.g., via the availability prediction module 250) a machine learning model (e.g., the availability prediction machine learning model 305) to information about the item (e.g., taxonomy of the item) and information about the source (e.g., source's inventory data received from the source computing system 120) to generate the item status signal with the indication about the real time status of the item at the source, such as a likelihood of availability of the item at the source. In one or more other embodiments, responsive to receiving the ordering signal, the online system 140 may send (e.g., via the availability prediction module 250), via the network and to a device associated with the source (e.g., the source computing system 120), a status request signal requesting a real time status of the item at the source. In such cases, the online system 140 may receive (e.g., at the availability prediction module 250), via the network and from the device associated with the source, the item status signal including information about the real time status of the item at the source.

Responsive to the item status signal indicating a potential unavailability of the item at the source (e.g., the likelihood of availability of the item at the source below a threshold likelihood), the online system 140 obtains 420 (e.g., via the availability prediction module 250), based at least in part on the set of features of the item, a set of candidate replacement items for replacing the item. The online system 140 accesses 425 an availability prediction model of the online system 140 (e.g., via the availability prediction module 250 or the user-agnostic availability module 260), wherein the availability prediction model is a machine learning model (e.g., the availability prediction machine learning model 305) that is trained to predict a likelihood that the item or a replacement item is available at the source.

The availability prediction model may be a machine learning model that can be trained in two stages. In the first stage of training, the availability prediction model is trained using user-agnostic signals. In the first stage of training, the online system 140 may retrieve (e.g., via the availability prediction module 250 or the user-agnostic availability module 260), from the database, information about a training set of conversions conducted by a training set of users of the online system 140. The online system 140 may further retrieve (e.g., via the availability prediction module 250 or the user-agnostic availability module 260), from the database, a set of labels, each label from the set of labels indicative of whether an originally requested item or a replacement item for replacing the originally requested item was available at a corresponding source during each conversion of the training set of conversions. The replacement item represents a suitable replacement for the originally requested item, i.e., the replacement item was accepted by a corresponding user from the training set of users. The online system 140 may apply the availability prediction model (e.g., via the availability prediction module 250 or the user-agnostic availability module 260) to the information about the training set of conversions to generate an output for each conversion of the training set of conversions that is indicative of a likelihood that the originally requested item or the replacement item was available at the corresponding source. The online system 140 may then compare (e.g., via the machine learning training module 230) the output for each conversion of the training set of conversions to a respective label from the set of labels. After that, the online system 140 may update (e.g., via the machine learning training module 230), using a result of comparing the output for each conversion to the respective label, a set of parameters of the availability prediction model.

The second stage of training is an optional training stage where the availability prediction model is trained using user specific signals. In the second stage of training, the online system 140 may retrieve (e.g., via the personalized availability module 270), from the database and for a plurality of conversions conducted by the user, user data including information about acceptance of alternative items instead of originally requested items for the user. The online system 140 may further retrieve (e.g., via the personalized availability module 270), from the database, a plurality of labels, each of the plurality of labels indicative of whether an item originally requested by the user or a corresponding alternative item for replacing the item originally requested by the user was available during each of the plurality of conversions. The corresponding alternative item represents a suitable replacement for the item originally requested by the user, i.e., the corresponding alternative item was accepted by the user. The online system 140 may apply the availability prediction model (e.g., via the personalized availability module 270) to the user data to generate a user specific output for each of the plurality of conversions that is indicative of a likelihood that the item originally requested by the user or the corresponding alternative item was available. The online system 140 may then compare (e.g., e.g., via the machine learning training module 230) the user specific output for each of the plurality of conversions to a respective label of the plurality of labels. After that, the online system 140 may update (e.g., via the machine learning training module 230), using a result of comparing the user specific output to the respective label, the set of parameters of the availability prediction model. In one or more embodiments, the first stage of training and the second stage of training occur simultaneously, i.e., the availability prediction model is trained using both user-agnostic signals and user specific signals.

The online system 140 applies 430 the availability prediction model (e.g., via the availability prediction module 250 or the user-agnostic availability module 260) to the set of features of the item, the item status signal, and the set of candidate replacement items to generate an availability score for the item that is indicative of a likelihood that the item or an alternative item for replacing the item is available at the source. The online system 140 compares 435 (e.g., via the availability prediction module 250 or the user-agnostic availability module 260) the availability score for the item to a threshold score.

The online system 140 generates 440 (e.g., via the content presentation module 210), using information about the item and when the availability score for the item is greater than the threshold score, a user interface signal. The online system 140 sends 445 (e.g., via the content presentation module 210), via the network, the user interface signal to the device associated with the user, wherein the sending the user interface signal causes the device associated with the user to display a user interface with the information about the item and a user interface element for adding the item to a cart of the user.

The online system 140 may retrieve (e.g., via the personalized availability module 270), from the database and using an identifier of the user, information about the user including at least one of a list of replacement items selected by the user for replacing one or more items, information about a rate with which the user selected replacement items when requested items are unavailable, or communications from the user in relation to past replacements. The online system 140 may apply the availability prediction model (e.g., via the personalized availability module 270) to the information about the user and the availability score for item to generate a user specific availability score for the item that is indicative of a likelihood that the item or another item preferred by the user for replacing the item is available at the source. The online system 140 may compare (e.g., via the personalized availability module 270) the user specific availability score for the item to the threshold score. Responsive to the user specific availability score for the item being above the threshold score, the online system 140 may generate (e.g., via the content presentation module 210), using information about the item, a second user interface signal. The online system 140 may send (e.g., via the content presentation module 210), via the network, the second user interface signal to the device associated with the user, wherein the sending the second user interface signal causes the device associated with the user to display the user interface with the information about the item and the user interface element for adding the item to the cart.

In one or more embodiments, responsive to receiving the ordering signal, the online system 140 retrieves (e.g., via the personalized availability module 270), from the database and using an identifier of the user, information about the user including at least one of a list of replacement items selected by the user for replacing one or more items, information about a rate with which the user selected replacement items when requested items are unavailable, or communications from the user in relation to past replacements. In such cases, the online system 140 may apply the availability prediction model (e.g., via the availability prediction module 250) further to the information about the user to generate the availability score for the item that is specific for the user.

The online system 140 may receive (e.g., at the order management module 220), from the network and the device associated with the user, information about a number of items in the cart and a total value of the cart. In such cases, the online system 140 may apply the availability prediction model (e.g., via the availability prediction module 250) further to the number of items in the cart and the total value of the cart to generate the availability score for the item. The online system 140 may further compare (e.g., via the availability prediction module 250) the total value of the cart to a threshold value for the cart (e.g., minimum value of the cart for free delivery) to generate a cart signal indicative of the total value of the cart relative to the threshold value. In such cases, the online system 140 may apply the availability prediction model (e.g., via the availability prediction module 250) further to the cart signal to generate the availability score for the item.

The online system 140 may receive (e.g., at the order management module 220), via the network and from the device associated with the user, a user action signal indicative of adding the item to the cart. The online system 140 may send (e.g., via the order management module 220), via the network and to a device associated with a picker (e.g., the picker client device 110), a dispatch signal prompting the picker to pick items from the cart at the source and deliver an order associated with the cart to the user. The online system 140 may receive (e.g., at the order management module 220), via the network and from the device associated with the picker, a delivery signal indicative of delivering the order to the user where the alternative item was delivered instead of the item.

The online system 140 may receive e.g., at the order management module 220), via the network and from the device associated with the user, communication data exchanged between the device associated with the user and a device associated with a picker (e.g., the picker client device 110) who delivered an order associated with the cart to the user where the alternative item was delivered instead of the item, the communication data indicative of a level of acceptance of the alternative item by the user (e.g., user's satisfaction about the alternative item). The online system 140 may update (e.g., via the machine learning training module 230), using the communication data, the set of parameters of the availability prediction model.

Embodiments of the present disclosure are directed to the online system 140 that trains a machine learning model to predict whether the online system 140 should display an item at a user interface of the online system 140. The machine learning model is a novel availability prediction model that is trained with a label indicating whether the item or a suitable replacement is available at a source. The availability prediction model presented herein can be personalized for a specific user of the online system 140 or generalized by utilizing only user-agnostic signals.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network and from a device associated with a user of an online system, an ordering signal including a request for an item from a source;
responsive to receiving the ordering signal, retrieving, from a database of the online system, a set of features of the item;
responsive to receiving the ordering signal, generating an item status signal with an indication about a real time status of the item at the source;
responsive to the item status signal indicating a potential unavailability of the item at the source, obtaining, based at least in part on the set of features of the item, a set of candidate replacement items for replacing the item;
accessing an availability prediction model of the online system, wherein the availability prediction model is a machine learning model that is trained by:
retrieving, from the database, information about a training set of conversions conducted by a training set of users of the online system,
retrieving, from the database, a set of labels, each label from the set of labels indicative of whether an originally requested item or a replacement item for replacing the originally requested item was available at a corresponding source during each conversion of the training set of conversions,
applying the availability prediction model to the information about the training set of conversions to generate an output for each conversion of the training set of conversions that is indicative of a likelihood that the originally requested item or the replacement item was available at the corresponding source,
comparing the output for each conversion of the training set of conversions to a respective label from the set of labels, and
updating, using a result of comparing the output for each conversion to the respective label, a set of parameters of the availability prediction model;
applying the availability prediction model to the set of features of the item, the item status signal, and the set of candidate replacement items to generate an availability score for the item that is indicative of a likelihood that the item or an alternative item for replacing the item is available at the source;
comparing the availability score for the item to a threshold score;
generating, using information about the item and when the availability score for the item is greater than the threshold score, a user interface signal; and
sending, via the network, the user interface signal to the device associated with the user, wherein the sending the user interface signal causes the device associated with the user to display a user interface with the information about the item and a user interface element for adding the item to a cart of the user.

2. The method of claim 1, further comprising:
retrieving, from the database and for a plurality of conversions conducted by the user, user data including information about acceptance of alternative items instead of originally requested items for the user;
retrieving, from the database, a plurality of labels, each of the plurality of labels indicative of whether an item originally requested by the user or a corresponding alternative item for replacing the item originally requested by the user was available during each of the plurality of conversions;
applying the availability prediction model to the user data to generate a user specific output for each of the plurality of conversions that is indicative of a likelihood that the item originally requested by the user or the corresponding alternative item was available;
comparing the user specific output for each of the plurality of conversions to a respective label of the plurality of labels; and
updating, using a result of comparing the user specific output to the respective label, the set of parameters of the availability prediction model.

3. The method of claim 2, further comprising:
retrieving, from the database and using an identifier of the user, information about the user;
applying the availability prediction model to the information about the user and the availability score for item to generate a user specific availability score for the item that is indicative of a likelihood that the item or another item preferred by the user for replacing the item is available at the source;
comparing the user specific availability score for the item to the threshold score;
responsive to the user specific availability score for the item being above the threshold score, generating, using information about the item, a second user interface signal; and
sending, via the network, the second user interface signal to the device associated with the user, wherein the sending the second user interface signal causes the device associated with the user to display the user interface with the information about the item and the user interface element for adding the item to the cart.

4. The method of claim 3, wherein retrieving the information about the user comprises:
retrieving, from the database, at least one of a list of replacement items selected by the user for replacing one or more items, information about a rate with which the user selected replacement items when requested items are unavailable, or communications from the user in relation to past replacements.

5. The method of claim 1, further comprising:
responsive to receiving the ordering signal, retrieving, from the database and using an identifier of the user, information about the user including at least one of a list of replacement items selected by the user for replacing one or more items, information about a rate with which the user selected replacement items when requested items are unavailable, or communications from the user in relation to past replacements,
wherein applying the availability prediction model comprises applying the availability prediction model further to the information about the user to generate the availability score for the item that is specific for the user.

6. The method of claim 1, further comprising:
receiving, from the network and the device associated with the user, information about a number of items in the cart and a total value of the cart,
wherein applying the availability prediction model comprises applying the availability prediction model further to the number of items in the cart and the total value of the cart to generate the availability score for the item.

7. The method of claim 6, further comprising:
comparing the total value of the cart to a threshold value for the cart to generate a cart signal indicative of the total value of the cart relative to the threshold value,
wherein applying the availability prediction model comprises applying the availability prediction model further to the cart signal to generate the availability score for the item.

8. The method of claim 1, wherein receiving the ordering signal comprises:
receiving, via the network and from the device associated with the user, a user mode signal that is indicative of the user not being logged in at an account of the user at the online system when requesting the item.

9. The method of claim 1, further comprising:
receiving, via the network and from the device associated with the user, a user action signal indicative of adding the item to the cart;
sending, via the network and to a device associated with a picker, a dispatch signal prompting the picker to pick items from the cart at the source and deliver an order associated with the cart to the user; and
receiving, via the network and from the device associated with the picker, a delivery signal indicative of delivering the order to the user where the alternative item was delivered instead of the item.

10. The method of claim 1, further comprising:
receiving, via the network and from the device associated with the user, communication data exchanged between the device associated with the user and a device associated with a picker who delivered an order associated with the cart to the user where the alternative item was delivered instead of the item, the communication data indicative of a level of acceptance of the alternative item by the user; and
updating, using the communication data, the set of parameters of the availability prediction model.

11. A computer program product comprising a non-transitory computer readable storage medium having instructions encoded thereon that, when executed by a processor, cause the processor to perform steps comprising:
receiving, via a network and from a device associated with a user of an online system, an ordering signal including a request for an item from a source;
responsive to receiving the ordering signal, retrieving, from a database of the online system, a set of features of the item;
responsive to receiving the ordering signal, generating an item status signal with an indication about a real time status of the item at the source;
responsive to the item status signal indicating a potential unavailability of the item at the source, obtaining, based at least in part on the set of features of the item, a set of candidate replacement items for replacing the item;
accessing an availability prediction model of the online system, wherein the availability prediction model is a machine learning model that is trained by:
retrieving, from the database, information about a training set of conversions conducted by a training set of users of the online system,
retrieving, from the database, a set of labels, each label from the set of labels indicative of whether an originally requested item or a replacement item for replacing the originally requested item was available at a corresponding source during each conversion of the training set of conversions,
applying the availability prediction model to the information about the training set of conversions to generate an output for each conversion of the training set of conversions that is indicative of a likelihood that the originally requested item or the replacement item was available at the corresponding source,
comparing the output for each conversion of the training set of conversions to a respective label from the set of labels, and
updating, using a result of comparing the output for each conversion to the respective label, a set of parameters of the availability prediction model;
applying the availability prediction model to the set of features of the item, the item status signal, and the set of candidate replacement items to generate an availability score for the item that is indicative of a likelihood that the item or an alternative item for replacing the item is available at the source;
comparing the availability score for the item to a threshold score;
generating, using information about the item and when the availability score for the item is greater than the threshold score, a user interface signal; and
sending, via the network, the user interface signal to the device associated with the user, wherein the sending the user interface signal causes the device associated with the user to display a user interface with the information about the item and a user interface element for adding the item to a cart of the user.

12. The computer program product of claim 11, wherein the instructions further cause the processor to perform steps comprising:
retrieving, from the database and for a plurality of conversions conducted by the user, user data including information about acceptance of alternative items instead of originally requested items for the user;
retrieving, from the database, a plurality of labels, each of the plurality of labels indicative of whether an item originally requested by the user or a corresponding alternative item for replacing the item originally requested by the user was available during each of the plurality of conversions;
applying the availability prediction model to the user data to generate a user specific output for each of the plurality of conversions that is indicative of a likelihood that the item originally requested by the user or the corresponding alternative item was available;
comparing the user specific output for each of the plurality of conversions to a respective label of the plurality of labels; and
updating, using a result of comparing the user specific output to the respective label, the set of parameters of the availability prediction model.

13. The computer program product of claim 12, wherein the instructions further cause the processor to perform steps comprising:
retrieving, from the database and using an identifier of the user, information about the user including at least one of a list of replacement items selected by the user for replacing one or more items, information about a rate with which the user selected replacement items when requested items are unavailable, or communications from the user in relation to past replacements;
applying the availability prediction model to the information about the user and the availability score for item to generate a user specific availability score for the item that is indicative of a likelihood that the item or another item preferred by the user for replacing the item is available at the source;
comparing the user specific availability score for the item to the threshold score;
responsive to the user specific availability score for the item being above the threshold score, generating, using information about the item, a second user interface signal; and
sending, via the network, the second user interface signal to the device associated with the user, wherein the sending the second user interface signal causes the device associated with the user to display the user interface with the information about the item and the user interface element for adding the item to the cart.

14. The computer program product of claim 11, wherein the instructions further cause the processor to perform steps comprising:
responsive to receiving the ordering signal, retrieving, from the database and using an identifier of the user, information about the user including at least one of a list of replacement items selected by the user for replacing one or more items, information about a rate with which the user selected replacement items when requested items are unavailable, or communications from the user in relation to past replacements; and
applying the availability prediction model further to the information about the user to generate the availability score for the item that is specific for the user.

15. The computer program product of claim 11, wherein the instructions further cause the processor to perform steps comprising:
receiving, from the network and the device associated with the user, information about a number of items in the cart and a total value of the cart; and
applying the availability prediction model further to the number of items in the cart and the total value of the cart to generate the availability score for the item.

16. The computer program product of claim 15, wherein the instructions further cause the processor to perform steps comprising:
comparing the total value of the cart to a threshold value for the cart to generate a cart signal indicative of the total value of the cart relative to the threshold value;
and applying the availability prediction model further to the cart signal to generate the availability score for the item.

17. The computer program product of claim 11, wherein the instructions further cause the processor to perform steps comprising:
receiving the ordering signal by receiving, via the network and from the device associated with the user, a user mode signal that is indicative of the user not being logged in at an account of the user at the online system when requesting the item.

18. The computer program product of claim 11, wherein the instructions further cause the processor to perform steps comprising:
receiving, via the network and from the device associated with the user, a user action signal indicative of adding the item to the cart;
sending, via the network and to a device associated with a picker, a dispatch signal prompting the picker to pick items from the cart at the source and deliver an order associated with the cart to the user; and
receiving, via the network and from the device associated with the picker, a delivery signal indicative of delivering the order to the user where the alternative item was delivered instead of the item.

19. The computer program product of claim 11, wherein the instructions further cause the processor to perform steps comprising:
receiving, via the network and from the device associated with the user, communication data exchanged between the device associated with the user and a device associated with a picker who delivered an order associated with the cart to the user where the alternative item was delivered instead of the item, the communication data indicative of a level of acceptance of the alternative item by the user; and
updating, using the communication data, the set of parameters of the availability prediction model.

20. A computer system comprising:
a processor; and
a non-transitory computer-readable storage medium having instructions that, when executed by the processor, cause the computer system to perform steps comprising:
receiving, via a network and from a device associated with a user of an online system, an ordering signal including a request for an item from a source;
responsive to receiving the ordering signal, retrieving, from a database of the online system, a set of features of the item;
responsive to receiving the ordering signal, generating an item status signal with an indication about a real time status of the item at the source;
responsive to the item status signal indicating a potential unavailability of the item at the source, obtaining, based at least in part on the set of features of the item, a set of candidate replacement items for replacing the item;
accessing an availability prediction model of the online system, wherein the availability prediction model is a machine learning model that is trained by:
retrieving, from the database, information about a training set of conversions conducted by a training set of users of the online system,
retrieving, from the database, a set of labels, each label from the set of labels indicative of whether an originally requested item or a replacement item for replacing the originally requested item was available at a corresponding source during each conversion of the training set of conversions,
applying the availability prediction model to the information about the training set of conversions to generate an output for each conversion of the training set of conversions that is indicative of a likelihood that the originally requested item or the replacement item was available at the corresponding source,
comparing the output for each conversion of the training set of conversions to a respective label from the set of labels, and
updating, using a result of comparing the output for each conversion to the respective label, a set of parameters of the availability prediction model;
applying the availability prediction model to the set of features of the item, the item status signal, and the set of candidate replacement items to generate an availability score for the item that is indicative of a likelihood that the item or an alternative item for replacing the item is available at the source;
comparing the availability score for the item to a threshold score;
generating, using information about the item and when the availability score for the item is greater than the threshold score, a user interface signal;
and sending, via the network, the user interface signal to the device associated with the user, wherein the sending the user interface signal causes the device associated with the user to display a user interface with the information about the item and a user interface element for adding the item to a cart of the user.
